(19) United States
(12) Patent Application Publication
(10) Pub. No.: US 2012/0314427 A1
(43) Pub. Date: Dec. 13, 2012

(54) LED HEAT SINK AND METHOD FOR MANUFACTURING THE SAME

(75) Inventors: Sheng-Huang Lin, New Taipei City (TW); Kuo-Sheng Lin, New Taipei City (TW)

(73) Assignee: ASIA VITAL COMPONENTS CO., LTD., New Taipei City (TW)

(21) Appl. No.: 13/156,316

(22) Filed: Jun. 8, 2011

(51) Int. Cl. F21V 29/00; B23P 17/04

(52) U.S. Cl. 362/373; 29/428

(57) ABSTRACT

The present invention relates to a LED heat sink and a method for manufacturing the same. According to the inventive method, ends of heat-dissipating fins are melted and combined with heat-conducting body by point discharge, thereby forming the LED heat sink. The LED heat sink includes the heat-conducting body and the heat-dissipating fins. The heat-conducting body has a heated portion and a heat-conducting portion. The heat-conducting portion is connected to the heat-dissipating fins. By this method, a heat sink of a complicated structure can be manufactured with multiple materials. Further, the working hours and production cost are reduced greatly.

### BACKGROUND OF THE INVENTION

1. Field of the Invention

The present invention relates to a LED heat sink and a method for manufacturing the same, and in particular to a LED heat sink and a method for manufacturing the same, whereby working hours and production cost are reduced.

2. Description of Prior Art

Light emitting diode (LED) is a solid light source which is capable of converting electricity into light energy, and it is made by a chip growth process together with a semiconductor process. The LED has a lot of advantages of small volume, low driving voltage, fast response, resistant to vibration, long lifetime, and conforms to the requirements for environmental protection. Further, with the advancement of science and technology, the light-emitting efficiency of LED increases continuously since 1960 to exceed that of an incandescent bulb (10-201 m/W) and that of a fluorescent lamp (60-801 m/W). Since the LED technology is still progressing, the light-emitting efficiency of the LED may achieve a level up to 1001 m/W in the close future. Since the LED has become a new-generation solid light source, and the size of electronic elements is now required to be made smaller for compact design, a LED bulb has replaced the traditional incandescent bulb and is widely used in traffic lights, street lamps, household lamps, automotive lamps, signboard lamps or the like to become a mainstream in the illumination market.

Since the current LED lamps are widely used with a better external appearance and brightness, the LED of a high brightness inevitably generates a greater amount of heat, so that it is necessary to provide an improved solution for the heat dissipation of the LED lamp.

Conventionally, a heat-dissipating element is incorporated into a LED lamp, and the profile of the heat-dissipating element corresponds to that of the LED lamp. Thus, the external appearance and structure of the heat-dissipating element for the LED lamp are more complicated than those of a traditional heat-dissipating element. Accordingly, the method for manufacturing the heat-dissipating element of the LED lamp is also complicated. The traditional heat-dissipating element is manufactured by the following steps of: punching a plurality of heat-dissipating fins, and stacking up the heat-dissipating fins to form a heat sink. Alternatively, an aluminum material is extruded to form a block-type heat sink. The above two methods can merely produce heat sinks of a simple structure, but cannot produce heat sinks of a complicated structure.

Further, the heat sink made by aluminum extrusion involves only one kind of material, so that the heat sink cannot be manufactured of at least two kinds of materials by extrusion.

Although the fin-type heat sink can be manufactured by assembling multiple kinds of materials into one body, such a method inevitably needs more working hours and production cost.

Therefore, the conventional heat sink has disadvantages as follows:

(I) complicated in structure and difficult to manufacture;

(II) unable to be made by multiple kinds of materials easily; and

(III) high production cost.

### SUMMARY OF THE INVENTION

In order to solve the above problems, a primary objective of the present invention is to provide a method for manufacturing a LED heat sink, which employs one or multiple kinds of materials to manufacture the heat sink.

Another objective of the present invention is to provide a method for manufacturing a LED heat sink, which is capable of reducing production cost.

A further objective of the present invention is to provide a method for manufacturing a LED heat sink, which has a better heat-dissipating effect.

In order to achieve the above objective, the present invention is to provide a method for manufacturing a LED heat sink, including steps of:

providing a heat-conducting body and defining a heat-conducting portion;

providing a plurality of heat-dissipating fins;

connecting ends of the heat-dissipating fins to the heat-conducting portion; and

combining the heat-dissipating fins with the heat-conducting portion by using point discharge.

In order to achieve the above objective, the present invention is to provide a LED heat sink, including:

a heat-conducting body having a heated portion and a heat-conducting portion extending from the heated portion; and

a plurality of heat-dissipating fins each having a connecting end and a heat-dissipating end, the connecting ends being connected to the heat-conducting portion, the heat-dissipating ends extending from the connecting ends to be opposite to the heat-conducting portion.

By using the present inventive LED heat sink and the method for manufacturing the same, the heat-dissipating efficiency of the LED heat sink is improved. Further, one or multiple kinds of materials can be used to manufacture the present inventive LED heat sink. Also, the amount of materials used and the production cost are reduced.

### BRIEF DESCRIPTION OF THE DRAWINGS

FIG. 1 is a flow chart showing the steps of the method for manufacturing a LED heat sink according to the present invention;

FIG. 2 is a schematic view showing the operation of the method for manufacturing a LED heat sink according to the present invention;

FIG. 3 is another flow chart showing the steps of the method for manufacturing a LED heat sink according to the present invention;

FIG. 4 is a schematic view showing another operation of the method for manufacturing a LED heat sink according to the present invention;

FIG. 5 is a perspective view showing the structure of the LED heat sink according to the present invention; and

FIG. 6 is a cross-sectional view showing the structure of the LED heat sink according to the present invention.

### DETAILED DESCRIPTION OF THE INVENTION

The above objectives and structural and functional features of the present invention will be described in more detail with reference to preferred embodiment thereof shown in the accompanying drawings

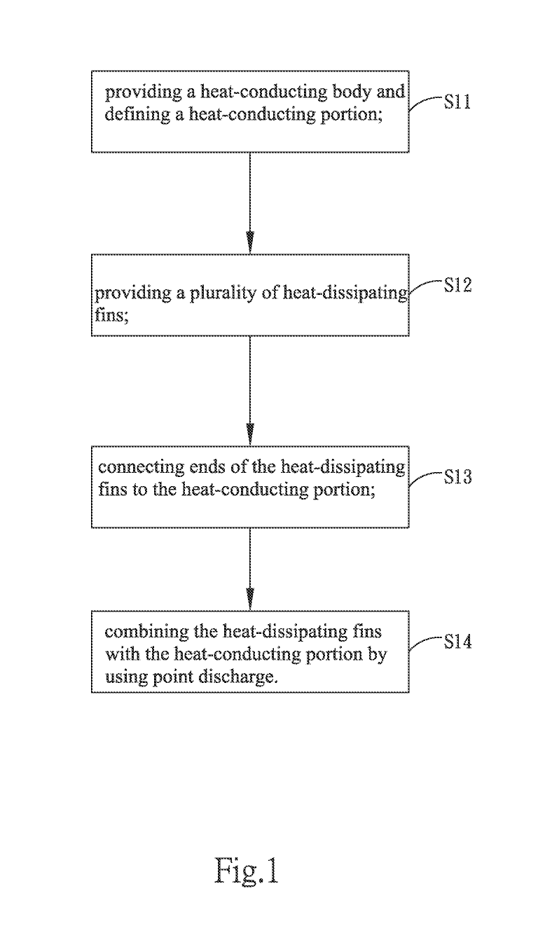

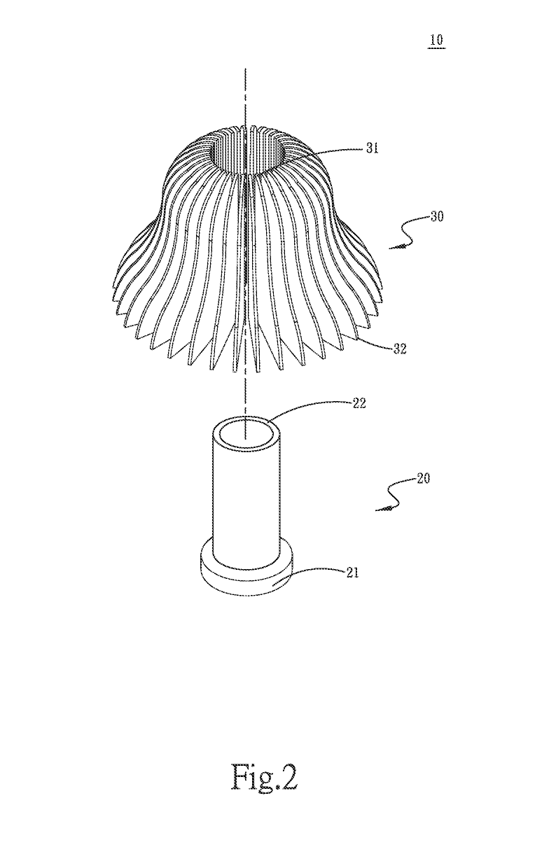

Please refer to FIGS. 1 and 2. FIG. 1 is a flow chart showing the steps of the method for manufacturing a LED heat sink according to the present invention, and FIG. 2 is a schematic view showing the operation of the method for manufacturing a LED heat sink according to the present invention. As shown in these figures, the method for manufacturing a LED heat sink includes steps as follows.

S11: providing a heat-conducting body and defining a heat-conducting portion.

In the step S11, a heat-conducting body 20 is provided. A heat-conducting portion 22 is defined in a portion of the heat-conducting body 20, and a heated portion 21 is defined in another portion of the heat-conducting body 20. The heat-conducting portion 22 extends from the heated portion 21. In the present embodiment, the heat-conducting portion 22 and the heated portion 21 are provided on both ends of the heat-conducting body 20 respectively.

S12: providing a plurality of heat-dissipating fins.

In the step S12, a plurality of heat-dissipating fins 30 is provided. Both ends of each of the heat-dissipating fins 30 are defined as a connecting end 31 and a heat-dissipating end 32 respectively.

S13: connecting ends of the heat-dissipating fins to the heat-conducting portion.

The connecting ends 31 formed on one end of the heat-dissipating fin 30 are connected to the heat-conducting portion 22, and the heat-dissipating ends 32 formed on the other end of the heat-dissipating fins 30 are provided to be opposite to the heat-conducting portion 22.

S14: combining the heat-dissipating fins with the heat-conducting portion by using point discharge.

By means of point discharge, the ends of the heat-dissipating fins 30 are melted and combined with the heat-conducting portion 22, thereby forming a LED heat sink 10.

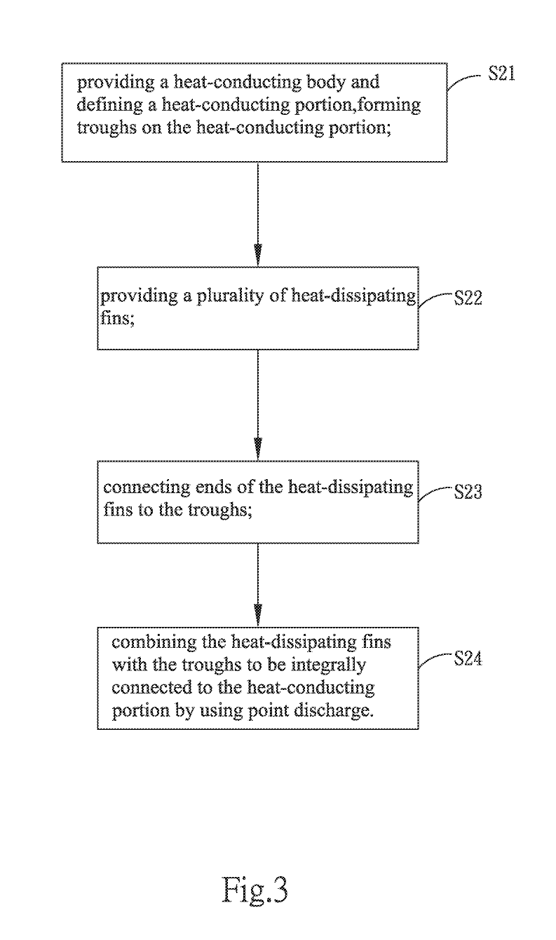

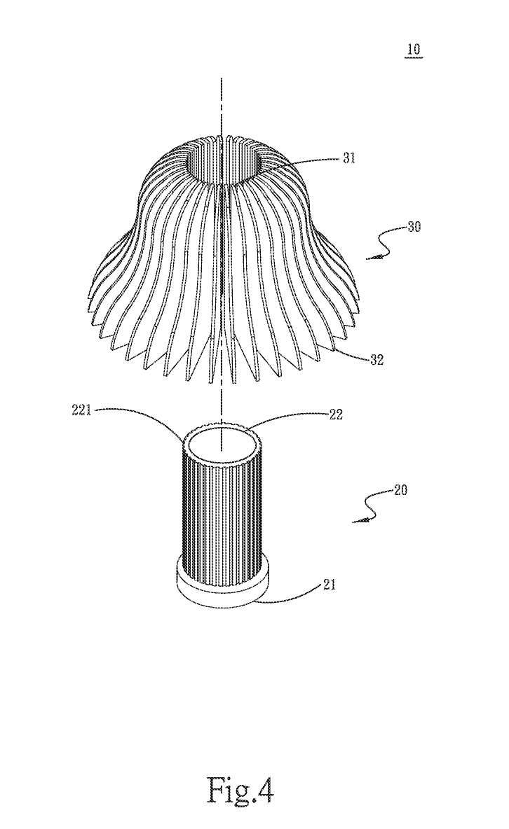

Please refer to FIGS. 3 and 4. FIG. 3 is another flow chart showing the steps of the method for manufacturing a LED heat sink according to the present invention, and FIG. 4 is a schematic view showing the operation of the method for manufacturing a LED heat sink according to the present invention. As shown in these figures, the method for manufacturing a LED heat sink includes steps as follows.

S21: providing a heat-conducting body and defining a heat-conducting portion.

In the step S21, a heat-conducting body 20 is provided. A heat-conducting portion 22 is defined in a portion of the heat-conducting body 20, and a heated portion 21 is defined in another portion of the heat-conducting body 20. The heat-conducting portion 22 extends from the heated portion 21. The heat-conducting portion 22 is formed with a plurality of troughs 221.

S22: providing a plurality of heat-dissipating fins.

In the step S22, a plurality of heat-dissipating fins 30 is provided. Both ends of each of the heat-dissipating fins 30 are defined as a connecting end 31 and a heat-dissipating end 32 respectively.

S23: connecting ends of the heat-dissipating fins to the troughs.

The connecting ends 31 formed on one end of the heat-dissipating fins 30 are connected to the troughs 221 of the heat-conducting portion 22, and the heat-dissipating ends 32 formed on the other end of the heat-dissipating fins 30 are provided to be opposite to the heat-conducting portion 22.

S24: combining the heat-dissipating fins with the troughs by using point discharge.

By means of point discharge, the ends of the heat-dissipating fins 30 are melted and combined with the troughs 221 to be integrally connected with the heat-conducting portion 22.

According to the above-mentioned methods, one or multiple kinds of materials can be used to manufacture the LED heat sink 10, thereby reducing the amount of materials used and production cost.

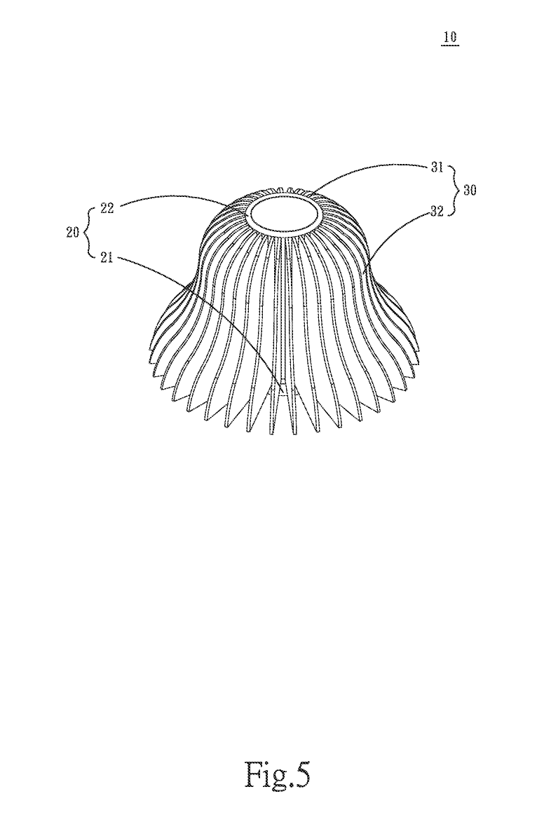

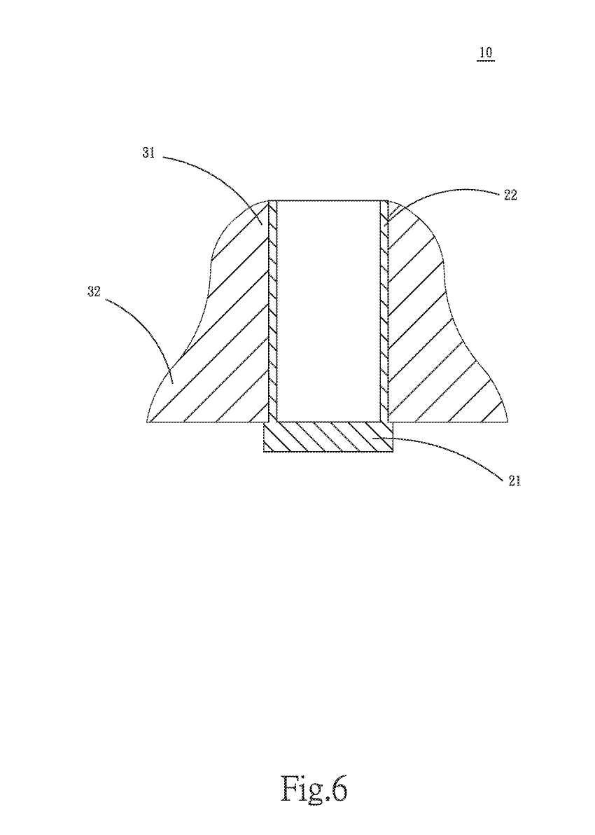

Please refer to FIGS. 5 and 6. FIG. 5 is a perspective view showing the structure of the LED heat sink according to the present invention, and FIG. 6 is a cross-sectional view showing the structure of the LED heat sink according to the present invention. The LED heat sink 10 comprises a heat-conducting body 20 and a plurality of heat-dissipating fins 30.

The heat-conducting body 20 has a heated portion 21. A heat-conducting portion 22 extends from one side of the heated portion 21.

Both ends of each heat-dissipating fin 30 have a connecting end 31 and a heat-dissipating end 32 respectively. The connecting end 31 is connected to the heat-conducting portion 22. The heat-dissipating end 32 extends from the connecting end 31 to be opposite to the heat-conducting portion 22.

The heat-conducting body 20 is a hollow cylindrical body. The heated portion 21 is formed on one side of the heat-conducting body 20. One side of the heated portion 21 extends to form the heat-conducting portion 22. The heat-conducting portion 22 extends from the heated portion 21 away from the heated portion 21. The outside of the heat-conducting portion 22 is connected to the heat-dissipating fins 30. The heat-dissipating fins 30 are radially arranged outside the heat-dissipating body 20 with equal intervals.

The heat-conducting body 20 and the heat-dissipating fins 30 may be made of equal material or different materials. In the present embodiment, the heat-conducting body 20 and the heat-dissipating fins 30 are made of different materials, but they are not limited thereto. The heat-conducting body 20 is made of a material of higher heat conductivity, such as copper. The heat-dissipating fins 30 are made of a material of greater heat-dissipating efficiency, such as aluminum. Of course, both the heat-conducting body 20 and the heat-dissipating fins 30 may be made of copper or aluminum.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A method for manufacturing a LED heat sink, including steps of:
providing a heat-conducting body and defining a heat-conducting portion;
providing a plurality of heat-dissipating fins;
connecting ends of the heat-dissipating fins to the heat-conducting portion; and
combining the heat-dissipating fins with the heat-conducting portion by using point discharge.

2. The method according to claim 1, wherein the ends of the heat-dissipating fins are melted and combined with the heat-conducting portion by the point discharge.

3. The method according to claim 1, wherein the heat-conducting portion and the heat-dissipating fins are made of a material selected from one of aluminum and copper.

4. The method according to claim 1, wherein the heat-conducting portion is defined in the heat-conducting body, a heated portion is also defined in the heat-conducting body, the heat-conducting portion extends from the heated portion.

5. The method according to claim 1, wherein both ends of each heat-dissipating fin have a connecting end and a heat-dissipating end, the connecting end is connected to the heat-conducting portion.

6. The method according to claim 4, wherein the heat-conducting portion is formed with a plurality of troughs, the troughs are connected to the ends of the heat-dissipating fins.

7. A LED heat sink, including:
a heat-conducting body having a heated portion and a heat-conducting portion extending from the heated portion; and
a plurality of heat-dissipating fins each having a connecting end and a heat-dissipating end, the connecting ends being connected to the heat-conducting portion, the heat-dissipating ends extending from the connecting ends to be opposite to the heat-conducting portion.

8. The LED heat sink according to claim 7, wherein the heat-conducting body and the heat-dissipating fins are made of equal material or different materials.

9. The LED heat sink according to claim 8, wherein the heat-conducting body and the heat-dissipating fins are made of a material selected from one of aluminum and copper.

10. The LED heat sink according to claim 8, wherein the heat-conducting body is made of copper, the heat-dissipating fins are made of aluminum.

11. The LED heat sink according to claim 8, wherein the heat-conducting body is made of aluminum, the heat-dissipating fins are made of copper.
